(19) United States
(12) Patent Application Publication
(10) Pub. No.: US 2021/0354635 A1
(43) Pub. Date: Nov. 18, 2021

(54) Car Safety Camera

(71) Applicant: Antonio Grace, Toano, VA (US)

(72) Inventor: Antonio Grace, Toano, VA (US)

(21) Appl. No.: 16/876,871

(22) Filed: May 18, 2020

(51) Int. Cl. B60R 11/04; G08G 1/16; B60Q 1/00; B60Q 1/26; B60R 1/12; G07C 5/08

(52) U.S. Cl. CPC B60R 11/04; G08G 1/167; B60Q 1/0023; B60R 2300/102; B60R 1/12; G07C 5/0891; B60Q 1/2665

(57) ABSTRACT

The disclosure includes a technology feature that uses an overhead view camera system to view and record any activity 360 degrees around the vehicle. The system includes four exterior cameras, an interior camera, a data collector, a wireless key remote, and a remote activation/viewing platform. Exterior cameras together have a 360 degree range around the vehicle.

### BACKGROUND OF THE INVENTION

### Field of Invention

The present invention relates to a technology feature for vehicles using an overhead view camera system.

### Description of Related Art

Vehicle safety as well as parking assistance have necessitated exterior vehicle cameras, like the overhead view camera system or bird's eye view camera system. Overhead view camera systems, also called bird's eye view camera systems, are currently implemented in various models of cars from various dealerships, such as Toyota, Nissan, and Volkswagen. The object of the present invention is to give consumers a more developed, more efficient, less expensive overhead view camera system to provide increased safety for vehicle owners.

### BRIEF DESCRIPTION OF DRAWINGS

FIG. 1 depicts the range of the exterior cameras from a bird's eye view of the vehicle in accordance with an embodiment of the present disclosure.

FIG. 2 depicts the location of the four exterior cameras and data collection by bird's eye view of the vehicle in accordance with an embodiment of the present disclosure.

FIG. 3 depicts a side view external camera with audio/visual recording on the side view mirror in accordance with an embodiment of the present disclosure.

FIG. 4 depicts the interior camera on the rear view mirror in accordance with an embodiment of the present disclosure.

FIG. 5 depicts a flow chart of a method for vehicle security in accordance to an embodiment of the present disclosure.

Throughout the description, same and similar reference numbers may be used to identify same and similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the term ‘photoreceptor’ refers broadly to a structure that responds to light falling on it such as a camera as a subset of the broader term.

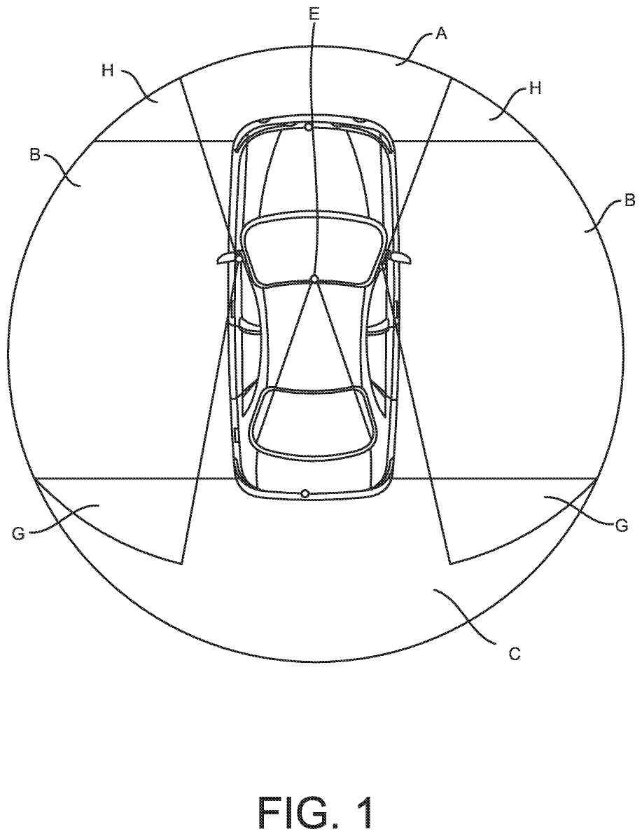

FIG. 1 depicts the range of the exterior cameras from a bird's eye view of the vehicle in accordance with an embodiment of the present disclosure. The front view camera shows a 180 degree view A of what is in front of the vehicle. The rear view camera shows a 180 degree view C of what is behind the vehicle. The side view cameras show a range B between what is viewed by the front and back cameras. There are minimal blind spots created by the interaction of the exterior cameras, such as by the front sides of the vehicle between the headlights and the side view mirror on both sides, and the back sides of the vehicle between the back door and the trunk on both sides. There are overlapping areas as well, with the front cameras and the side cameras, and the back camera and the side cameras. The interior of the vehicle is viewed by the interior discrete camera E. The range of this camera is limited to the center middle and back seat of the vehicle.

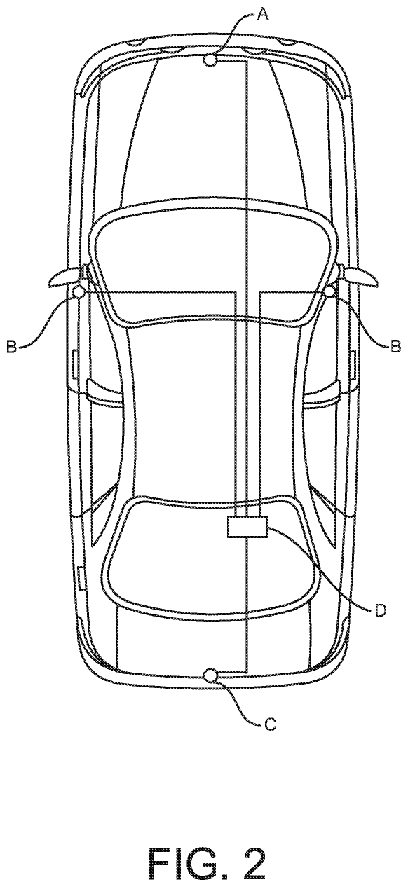

FIG. 2 depicts the location of four exterior cameras and a data collector from a bird's eye view of the vehicle in accordance with an embodiment of the present disclosure. The front view camera A is placed on the radiator grille. Two side view cameras with audio and visual recording B are placed on each side view mirror, on the side facing out. The data collector D takes audio and visual recording from each of the four exterior cameras. The rear view camera with audio and visual recording C is located on the back of the vehicle, on the tailgate handle or the trunk, facing out.

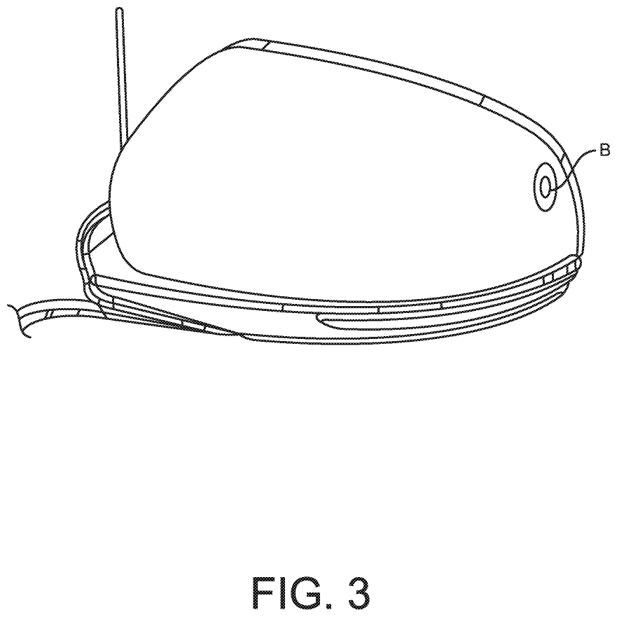

FIG. 3 depicts a side view external camera with audio/visual recording on the side view mirror in accordance with an embodiment of the present disclosure.

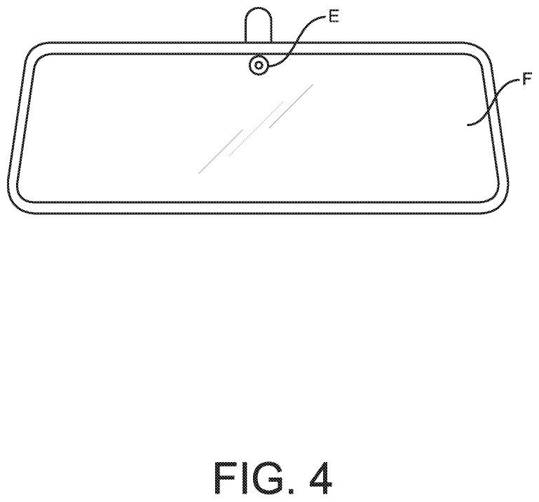

FIG. 4 depicts the interior camera on the rear view mirror in accordance with an embodiment of the present disclosure.

All cameras may be activated to record while inside the car and remotely. It may also be activated by the motion sensor, whenever there is movement around the car. An Event Data Recorder or EDR, sometimes referred to informally as an automotive “black box”, is an internal device that has the capabilities of recording the car speed five to ten minutes prior to being activated.

This device will have an internal memory card. The recording will be stored inside the car as well as to a remote location once the vehicle device is activated. This device can eventually store recorded data through voice over Blockchain. Initially it can record both video, voice and third party, e.g. a retained lawyer, automatically connected to the automobile's phone. It would also provide a remote safe keeping of the recording that can be sent immediately to a cell phone, social media outlet as well as a network so a lawyer on retainer can access the environment of the vehicle being pulled over as well as having a solid recording of the vehicle's speed.

The vehicle will have a specific Bar Code sticker on the rear of the car back windshield that can be scanned with a mobile phone or police scanner to identify who the owner of the car is as well as their potential medical warnings to the Police Officer. i.e. Arthritis, PTSD, Deaf, or other handicap or any other medical conditions which could cause the driver to have difficulties to keep their hands on the steering wheel or proclivity to sudden movements or stress.

The Be Safe Device will operate by direct current vehicle battery power or by solar panel and device power. This device will also have a panic key remote. The panic key remote will call first responders when activated.

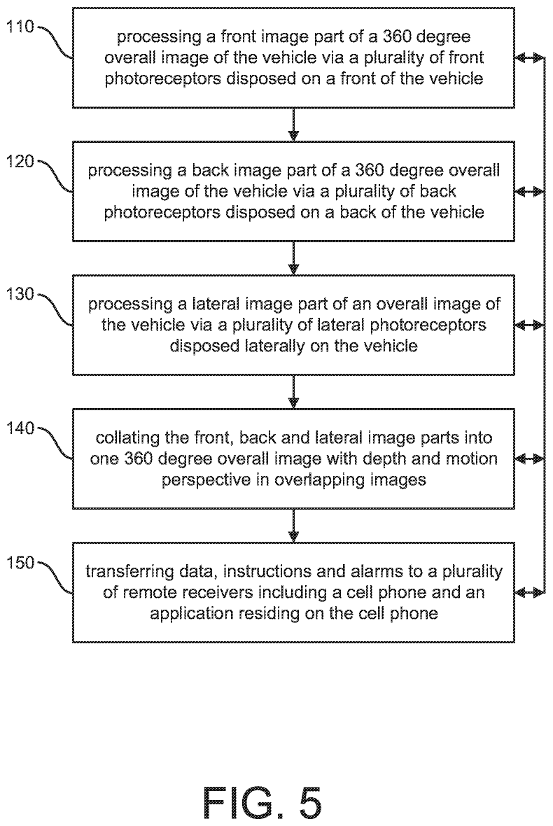

FIG. 5 depicts a flow chart for vehicle security in accordance with an embodiment of the present disclosure. The method includes 110 processing a front image part of a 360 degree overall image of the vehicle via a plurality of front photoreceptors disposed on a front of the vehicle. The method also includes 120 processing a back image part of a 360 degree overall image of the vehicle via a plurality of back photoreceptors disposed on a back of the vehicle. The method additionally includes 130 processing a lateral image part of an overall image of the vehicle via a plurality of lateral photoreceptors disposed laterally on the vehicle. The method further includes 140 collating the front, back and lateral image parts into one 360 degree overall image with depth and motion perspective in overlapping images via a digital signal processor. Embodiments of the method include 150 transferring data, instructions and alarms to a plurality of remote receivers including a cell phone and an application residing on the cell phone via an electronic communications module connected to the digital signal processor.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A What is claimed is:
A vehicle security system comprising:
a plurality of front photoreceptors disposed on a front of the vehicle, the front photoreceptors configured to provide a front image part of a 360 degree overall image of the vehicle;
a plurality of back photoreceptors disposed on a back of the vehicle, the back photoreceptors configured to provide a back image part of the 360 degree overall image of the vehicle;
a plurality of lateral photoreceptors disposed laterally on the vehicle, the lateral photoreceptors configured to provide a lateral image part of the 360 degree overall image of the vehicle; and
a digital signal processor configured to collect and combine the front, back and lateral image parts into one 360 degree overall image with depth and motion perspective in overlapping images.

2. The system of claim 1, wherein the overlapping images comprise a plurality of lateral front and lateral back images.

3. The system of claim 1, wherein the digital signal processor is in communication with the front, the back and the lateral photoreceptors via a plurality of wires.

4. The system of claim 1, wherein the digital signal processor is in communication with the front, the back and the lateral photoreceptors via a wireless signal communication.

5. The system of claim 1, wherein the front photoreceptors are disposed on an inside surface of a front windshield of the vehicle looking 180 degrees outward through the front windshield.

6. The system of claim 1, wherein the lateral photoreceptors are disposed on a left and on a right side view mirror of the vehicle looking 180 degrees laterally outward.

7. The system of claim 1, wherein the back photoreceptors are disposed on an inside surface of a back windshield of the vehicle looking 180 degrees outward through the back windshield.

8. The system of claim 1, further comprising a plurality of interior photoreceptors disposed on a rear view mirror of the vehicle the interior looking 180 degrees through all vehicle windows.

9. The system of claim 1, wherein the digital signal processor is configured to collect and combine the front, back, lateral and an interior image parts into one 360 degree overall image with depth and motion perspective in overlapping images.

10. The system of claim 1, further comprising a communication module connected to the digital signal processor to transfer data, instructions and alarms to a plurality of remote receivers.

11. (canceled)

12. (canceled)

13. (canceled)

14. (canceled)

15. (canceled)

16. (canceled)

17. (canceled)

18. (canceled)

19. (canceled)

20. A vehicle security communications system comprising:
a plurality of front photoreceptors disposed on a front of the vehicle, the front photoreceptors configured to provide a front image part of a 360 degree overall image of the vehicle;
a plurality of back photoreceptors disposed on a back of the vehicle, the back photoreceptors configured to provide a back image part of the 360 degree overall image of the vehicle;
a plurality of lateral photoreceptors disposed laterally on the vehicle, the lateral photoreceptors configured to provide a lateral image part of the 360 degree overall image of the vehicle;
a digital signal processor configured to collect and combine the front, back and lateral image parts into one 360 degree overall image with depth and motion perspective in overlapping images; and
an electronic communications module connected to the digital signal processor to transfer data, instructions and alarms to a plurality of remote receivers including a cell phone.
